(19) United States
(12) Patent Application Publication
(10) Pub. No.: US 2005/0249565 A1
(43) Pub. Date: Nov. 10, 2005

(54) Method and device for chucking rotationally symmetrical bodies and configuration of the body to be chucked

(75) Inventors: Alfred Mueller, Lenzburg (CH); Franz Knecht, Dottingen (CH)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: ABB TURBO SYSTEMS AG, CH-5400 BADEN (CH)

(21) Appl. No.: 10/522,882

(22) PCT Filed: Jul. 30, 2003
(86) PCT No.: PCT/CH03/00518

§ 371 Date: Feb. 2, 2005

(30) Foreign Application Priority Data
Aug. 2, 2002 (EP) 2405676.4

(51) Int. Cl. B23C 1/00

(52) U.S. Cl. 409/132

(57) ABSTRACT

A method of clamping a rotationally symmetrical body (10) for the purpose of machining, in which method the body (10), with its first side (12), is pulled by means of a tensile force (F1), which acts in extension of the rotation axis (19, 19′) of the body (10) on the first side (12) of the body (10), against a supporting element (72) having a centering effect.

A device for clamping a rotationally symmetrical body (10) for the purpose of machining, which device comprises a supporting element (72), against which the body (10) can be pulled, and a tie rod (64) which can act on and pull the body (10), to be clamped, axially and concentrically to the rotation axis (19, 19′) of the latter. The mounting of the tie rod (64) is designed in such a way that the tie rod (64) is axially guided with radial clearance (66) for the axial pulling movement. The tensile force (F1) of the tie rod (64) is preferably adjustable.

A rotationally symmetrical body (10), in particular a rotor, which, on a first side (12), has a coupling unit (18), which is concentric with its rotation axis (19), and a bearing region (22) having at least three bearing surfaces (24) arranged concentrically to the rotation axis (19).

### TECHNICAL FIELD

The invention relates to the field of machining of rotationally symmetrical bodies, specifically rotors, such as compressor wheels, turbine wheels, compressors and the like. In particular, it relates to a method of clamping rotationally symmetrical bodies according to the preamble of the method claim, to a device for clamping rotationally symmetrical bodies according to the preamble of the device claim, and to a rotationally symmetrical body according to the preamble of the object claim.

### PRIOR ART

Many rotationally symmetrical bodies which are subsequently used in machines or are used in another way, such as, for example, pipes, shafts, spindles, wheels, rotors, are first of all produced in the form of blanks which have the basic shape of the desired body. The blanks may be produced, for example, by casting, sintering, die-casting, forging, etc. In order to give the blanks the desired final shape, subsequent machining is usually still required, such as, for example, cutting, drilling, turning, milling, grinding, etc. To this end, the bodies are clamped in a corresponding machine by means of chucks. As a rule, the chuck comprises a collet, which as a rule, for rotationally symmetrical bodies, has at least three chuck jaws. However, centered clamping of rotationally symmetrical bodies is only possible to a limited extent with these commercially available chucks. The reproducibility of the clamping process is therefore unsatisfactory as a rule and leads to considerable errors during the machining of a workpiece in a plurality of clamping sequences. In the case of precision-cast, rotationally symmetrical workpieces, these errors may lead to an unbalance behavior which cannot be tolerated.

### SUMMARY OF THE INVENTION

An object of the invention is therefore to specify a method and a device with which rotationally symmetrical bodies can be reproduced and can be clamped coaxially and in a stable manner with high precision. A further object is to present rotationally symmetrical bodies which can be clamped in a simple and precise manner using the method specified and the device specified, which simplify the clamping process and improve the reproducibility or make it possible at all.

This object is achieved by a method having the features of the method claim, by a device according to the features of the device claim and by a rotationally symmetrical body according to the features of the object claim.

In the method according to the invention for clamping a rotationally symmetrical body for the purpose of machining, the rotationally symmetrical body, with its first side, is pulled by means of a tensile force, which acts in extension of the rotation axis of the body on the first side of the body, against a supporting body having a centering effect. Due to the fact that the rotationally symmetrical body, by means of the tensile force acting along its rotation axis, is fixed to the supporting element having a centering effect, the body cannot become canted, as is otherwise the case in the chuck jaws working with a laterally acting compression force.

The supporting element is given a centering effect, for example, by being acted upon by a spring force which counteracts the tensile force. If the spring force is slightly smaller than the tensile force and is proportioned in such a way that, when the body strikes the supporting element, the supporting element first of all yields in the axial direction, it is possible to pull the rotationally symmetrical body concentrically against the supporting element in an even more precise manner and to fix it in this way. The tensile force can be transmitted to the body in a very simple manner by means of a type of tie rod, which is connected to the body simply and quickly, for example by means of a quick-action coupling.

It is especially advantageous to move the tie rod in such a way that it is guided with radial clearance axially and concentrically to the rotation axis of the rotationally symmetrical body. The radial clearance, in an especially advantageous manner in interplay with the supporting element acted upon by spring force, produces accurate, concentric fixing against the supporting element without canting of the body.

If the body, with a centering region which is arranged at an axial distance from the first side of the body and is oriented in the same direction as the first side, is additionally pulled against an axially fixed centering device, even more stable fixing of the body is obtained, this fixing stabilizing the precise concentric position of the body even against vibrations. This is very advantageous in particular during machining operations in which very large forces act on the body. In this case, the centered clamping of the body is more stable, the closer the centering device acts to the location at which the machining acts.

Very good clamping results are obtained if spring force, tensile force and the configuration of supporting element and, if appropriate, centering device are selected in accordance with the body to be clamped.

If the rotationally symmetrical body to be clamped is a rotor having integrally formed blades, especially stable clamping is obtained if a centering device is selected whose centering surfaces engage between the blades in a finger-like manner. However, depending on the material and the blade shape, it may also possibly be more advantageous to work with a centering device whose centering surfaces interact with the blade edges.

The abovedescribed method for clamping a rotationally symmetrical body for the purpose of machining can be carried out with a device which comprises a tie rod which is guided axially with radial clearance in a wall, forming a supporting element for the body, of the device in such a way that it can act on the body, to be clamped, axially and concentrically to the rotation axis of the latter.

Especially good centering can be achieved with a supporting element which is movable in the axial direction, preferably free of play, and which is supported on a fixed stop of the device, in particular in a spring-loaded manner. It is especially advantageous if the supporting element is either of bell-shaped design, so that it can enclose in a centering manner a body to be clamped, or if it is designed in the form of an arbor or center which can then engage in a centering manner in a recess or concavely designed bearing surfaces of the body to be clamped.

If the tie rod is provided with a coupling device which is preferably designed in the form of a quick-action coupling and can be connected to a coupling unit of the body to be clamped, the body to be clamped can be clamped in the device and also removed again from the device very simply and in particular quickly.

If the supporting element is provided with supporting surfaces which are arranged concentrically to the rotation axis of the body to be clamped, this promotes concentric clamping. Especially good results are achieved with a supporting element whose supporting surfaces are inclined toward the rotation axis. For certain rotationally symmetrical bodies, it may be advantageous if the supporting surfaces are contiguous at least along a defined outer circumference and form an annular supporting surface. For other rotationally symmetrical bodies, it may be more favorable if the supporting surfaces are distributed uniformly over the circumference and extend more radially.

A fixed centering device which is arranged at an axial distance from the supporting element and which is provided with centering surfaces which are arranged concentrically to the rotation axis of the body to be clamped and are preferably inclined toward the rotation axis enables rotationally symmetrical bodies to be clamped in an even more reliable manner.

Especially good clamping results can be achieved with a device according to the invention in which the tensile force of the tie rod and the spring force counteracting the tensile force are adjustable. Interchangeable supporting elements of different configuration and, if a centering device is present, interchangeable centering devices of different configuration likewise contribute to very good clamping results. Supporting element, centering device, spring force and tensile force can then be selected in adaptation to the body to be clamped (geometry, weight, etc.). For example, centering devices having centering surfaces which are distributed uniformly over the circumference and which extend in a finger-like manner toward the rotation axis from a defined outer circumference up to a defined inner circumference are very favorable, in particular for rotationally symmetrical bodies such as rotors having moving blades. The number of centering surfaces must then be freely matched to the number of moving blades of the rotor, so that the centering surfaces engage between the moving blades.

Rotationally symmetrical bodies, in particular rotors, which, on a first side, have a coupling unit, which is concentric with its rotation axis, and a bearing region having at least three bearing surfaces arranged concentrically to the rotation axis are especially suitable for the clamping, by the method according to the invention, in the device according to the invention. In this case, the bearing surfaces are oriented away from the center of the body toward the first side. The coupling unit can be stressed in tension and can be connected in an especially simple manner to a coupling device of diametrically opposed configuration. For rapid clamping and unclamping, it is advantageous if the coupling unit is configured in the form of a quick-action coupling. This can be realized in a very simple manner with a coupling unit which essentially has the shape of a concentric hollow cylinder and/or hollow polygon arranged in the body. In an advantageous configuration, the coupling unit is designed as the one half of a bayonet catch; in another advantageous configuration, it is designed as the one half of a screwed connection. The bayonet catch advantageously has a stop as overtightening protection, as is known for bayonet catches. The rotationally symmetrical body can be clamped in an especially precise manner if the bearing surfaces are inclined toward the rotation axis and enclose with the rotation axis an obtuse angle α within the range of 100° to 170°, preferably 120° to 150° and in particular 135°. For this purpose, however, the bearing surfaces may also be configured as surfaces curved convexly or concavely toward the rotation axis and toward the first side. Depending on the weight and geometry of the rotationally symmetrical body, it may be advantageous if the bearing surfaces are connected to one another and form a closed annular surface.

If at least three concentric centering regions are provided on the second side of the body, the bearing surfaces of these centering regions being oriented toward the first side of the body and preferably being inclined toward the rotation axis, the body can also be clamped by means of a centering device and can thus be fixed in an especially effective manner. Here, too, it has proved to be advantageous if the bearing surfaces are designed to be inclined toward the rotation axis. The angle of inclination β for the bearing surfaces of the centering regions lies within the range of 15° to 100°, preferably 20° to 60° and in particular is around 30°. Another good possibility consists in designing these bearing surfaces as surfaces curved convexly or convcavely toward the rotation axis. Here, too, it may be advantageous if the bearing surfaces are connected to one another and form an annular surface.

If the body has a marking which always permits an identical spatial orientation of the body, precise clamping which is always identical can also be ensured during resetting.

The simplest way of producing the rotationally symmetrical body is to produce it as a cast body. In this case, the coupling unit, the bearing surfaces and preferably, if present, also the marking can already be produced simply and cost-effectively essentially by casting.

Rotors, in particular having moving blades integrally formed in one piece, can also be produced very advantageously in the form of rotationally symmetrical bodies described above. It is especially advantageous in such rotors to arrange the bearing surfaces, at least on the second side of the body, between the moving blades and to integrate the coupling unit preferably in the hub.

Further preferred embodiments are the subject matter of further dependent patent claims.

### BRIEF DESCRIPTION OF THE DRAWINGS

The subject matter of the invention is explained in more detail below with reference to preferred exemplary embodiments which are shown in the attached drawings, in which, purely schematically:

FIG. 1 shows a rotationally symmetrical body according to the invention in a section along its rotation axis;

FIG. 2 shows another embodiment of a rotationally symmetrical body according to the invention, to be precise in the form of a rotor, in a section along its rotation axis;

FIG. 3 shows a further embodiment of a rotationally symmetrical body according to the invention, in the form of a rotor, likewise in section along its rotation axis;

FIG. 4 shows the rotationally symmetrical body from FIG. 3, top half of figure, in section along line IV-IV;

FIG. 5 shows the rotationally symmetrical body from FIG. 3, bottom half of figure, in section along line V-V;

FIG. 6 shows the device according to the invention for clamping the rotationally symmetrical body, in a partial view in section along the rotation axis of the body to be clamped;

FIG. 7 shows the rotationally symmetrical body from FIG. 2 clamped in the device according to the invention shown in FIG. 6;

FIG. 8 shows an embodiment of a centering device belonging to the device according to the invention, in side view according to arrows VIII-VIII in FIG. 6; and

FIG. 9 shows a further embodiment of a centering device in an illustration similar to FIG. 8.

The reference numerals used in the drawings and their meaning are compiled in the list of reference numerals.

In principle, the same parts are provided with the same reference numerals. The embodiment described represents the subject matter of the invention by way of example and has no restrictive effect.

Ways of Implementing the Invention

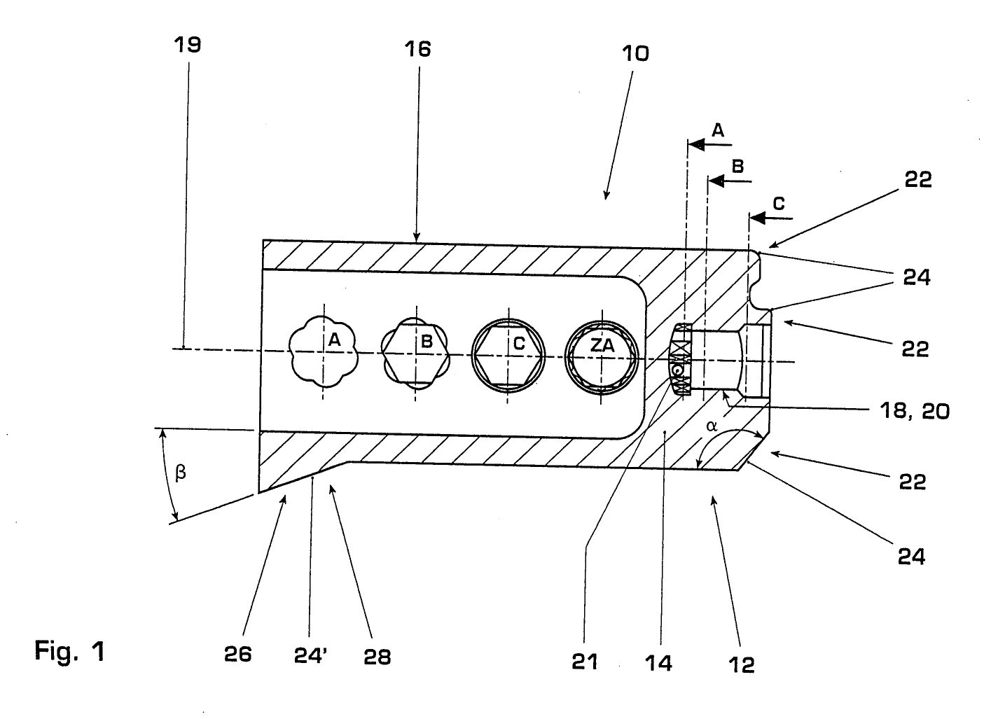

FIG. 1 shows a rotationally symmetrical body 10 in the form of a hollow cylinder 16 closed on a first side 12 by means of an integrally formed lid 14. The lid 14 on the first side 12 of the body 10 has a coupling unit 18 which extends essentially in the direction of the rotation axis 19 of the rotationally symmetrical body 10. The coupling unit 18 is the first half of the quick-action coupling, which in this example is configured as a bayonet catch 20. The coupling unit 18 can be stressed in tension. It is designed in the form of hollow-cylindrical or hollow-polygonal shapes of different diameter (cf. sections A, B, C, ZA) which follow one another in such a way that a coupling device of diametrically opposed design which forms the second half of the quick-action coupling can be pushed axially into the hollow shape of the coupling unit 18 and can then be locked by rotation. For the locking, a recess 21 is provided in the head region A of the coupling unit 18, it being possible for a corresponding locking pin of the second half, to be pushed in, of the quick-action coupling to engage in this recess 21. At least one bearing region 22 is provided on the first side 12 of the rotationally symmetrical body 10, this bearing region 22, as shown in the bottom half of FIG. 1, having three bearing surfaces 24 which are arranged concentrically to the rotation axis 19, are inclined at an angle α of about 135° to the rotation axis 19 and are distributed uniformly over the circumference. The angle of inclination α, adapted to the respective requirements, may lie within a range of 100° to 170°. Angles α within the range of 120° to 150° and specifically of 135° have proved to be especially suitable. On a second side 26 of the rotationally symmetrical body 10 which is opposite the first side 12, a centering region 28 is provided at an axial distance from the bearing region 22 in the embodiment shown in the bottom half of FIG. 1, this centering region 28 having three bearing surfaces 24′ which are arranged concentrically to the rotation axis 19 and are inclined toward the first side 12 and toward the rotation axis 19. The angle of inclination β is about 30°. However, an angle of inclination β within the range of 15° to 100° is possible. In the example shown in the bottom half of the figure, the bearing surfaces 24′ are contiguous to one another in the circumferential direction and form an annular surface. Instead of inclined bearing surfaces 24′, bearing surfaces which are convexly or concavely arched toward the first side 12 and the rotation axis 19 are also conceivable in the centering region 28 in principle (not shown).

As shown in the top half of FIG. 1, instead of one bearing region 22, a plurality of bearing regions 22 may be provided on the first side 12 of the rotationally symmetrical body 10. The top half of FIG. 1 shows, on the first side 12 of the rotationally symmetrical body 10, two bearing regions 22 having bearing surfaces 24 which are convexly curved respectively to the first side 12 and toward the rotation axis 19 and which, in this example, are in each case designed as closed annular surfaces. The two annular bearing surfaces 24 are arranged at both an axial and a radial distance from one another by means of a shoulder incorporated in the end face of the lid 14. Of course, instead of concave bearing surfaces 24, it is also conceivable to provide convexly curved bearing surfaces (not shown). As the example shown in the top half of the figure shows, the centering region 28 on the second side 26 of the rotationally symmetrical body 10 may also be omitted if it is not necessary for the reliable and concentric clamping, e.g. if the body 10 is lightweight and in the case of a small axial extent. The body 10 shown in FIG. 1 is an example of a pipe length in which the lid 14 with the coupling unit 18 is cut off after the machining has been completed. Bodies of similar configuration in which the lid 14 with coupling piece 18 is either only partly cut off or is not cut off at all may serve, for example, as housing parts.

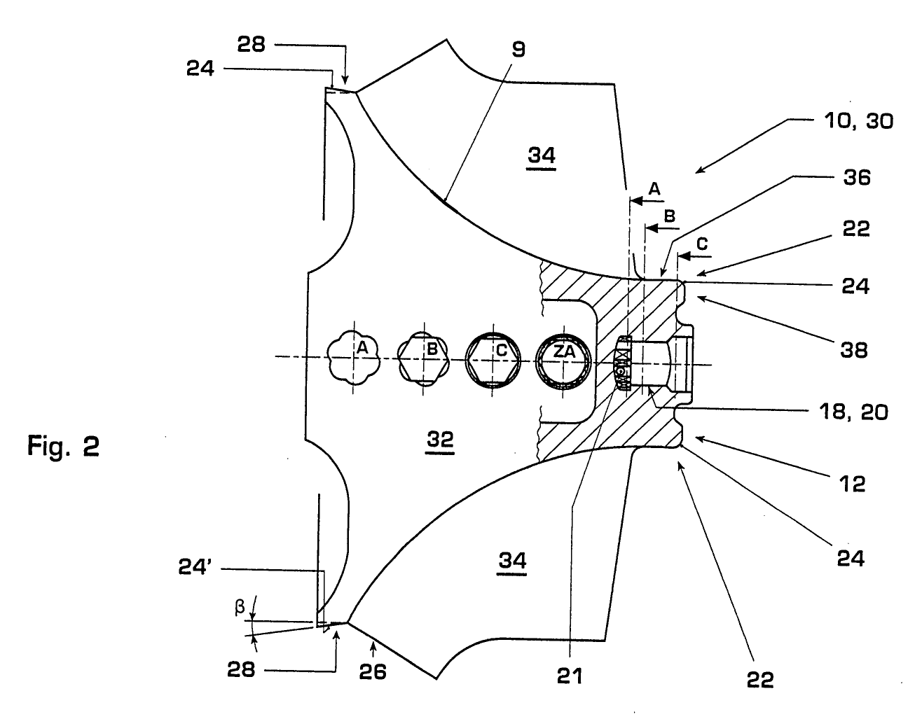

FIG. 2 shows a rotationally symmetrical body 10 which is designed in the form of a rotor 30 having a hub 32 and having moving blades 34 integrally formed on the hub 32. The hub 32 projects beyond the moving blades 34 axially on the first side 12 of the rotor 30. The transition from an approximately cylindrical outer surface 36 of this projecting part of the hub 32 to its end face 38 is designed as a bearing region 22 having an annular bearing surface 24 inclined convexly toward the first side 12 and the rotation axis 19. On the first side 12 of the rotor 30, a coupling unit 18 is provided in the hub 32. The coupling unit 18 is identical to the bayonet catch 18/20 shown in FIG. 1. Provided on the second side 26 of the rotor is a centering region 28 which projects axially beyond the moving blades 34 toward the second side. The centering region 28 has bearing surfaces 24′ which are inclined toward the first side 12 and the rotation axis 19 of the rotor 30.

The angle of inclination β is about 20° in this example. In this example, the individual bearing surfaces 24′ are connected to one another in the circumferential direction and form an annular surface. The rotor 30 shown in this figure is a rotor 30 which is cast in one piece and which has an integrally cast marking 9 between two moving blades 34 on the hub 32, this marking 9 allowing the rotor 30 to always be spatially oriented identically and allowing it to always be clamped with the same degree of accuracy in a device according to the invention.

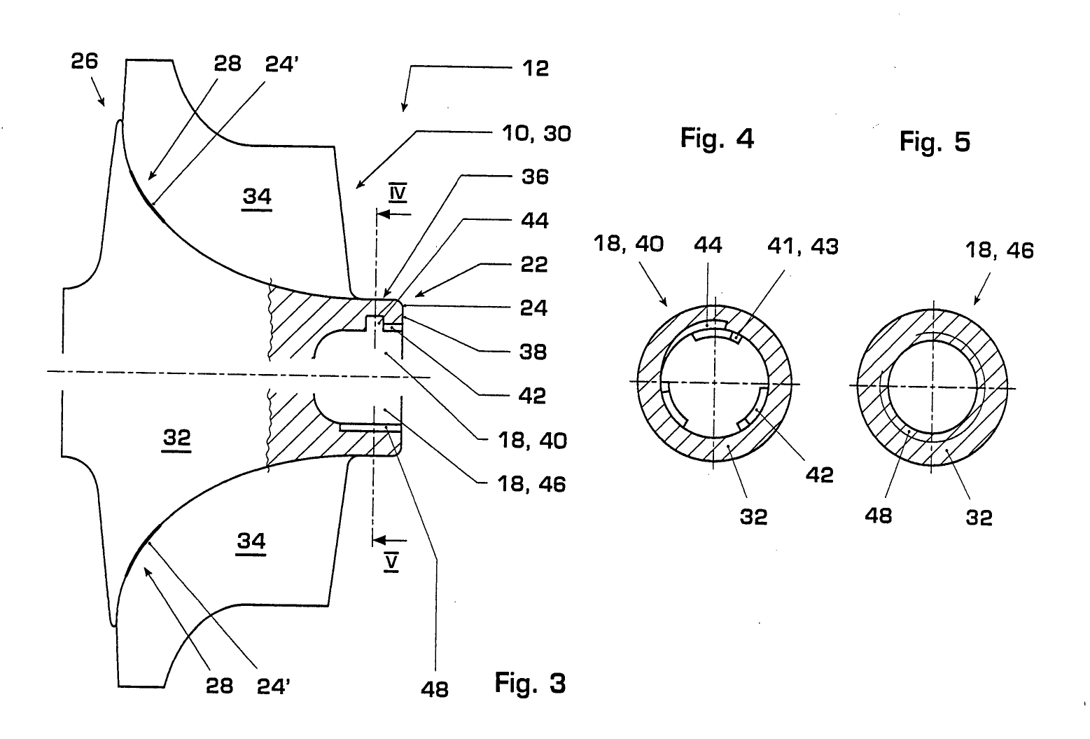

A further embodiment of a rotor 30 with hub 32 and moving blades 34 is depicted in FIG. 3 as a further example of a rotationally symmetrical body 10. The rotor 30 is in principle of the same construction as that in FIG. 2. In this case, however, the centering region 28 on the second side of the rotor 30 does not project axially beyond the moving blades 34. On the contrary, the bearing surfaces 24′ of the centering region 28 are in this case arranged in a uniformly distributed manner over the circumference in a concentric ring between the moving blades 34. In order to indicate them more clearly, they are identified by a greater line thickness. In this case, the bearing surfaces 24′ are concavely arched toward the first side 12 of the rotor 30 and its rotation axis 19. On the first side 12 of the rotor 30, as in the rotor in FIG. 2, the transition from the approximately cylindrical outer surface 36 of the projecting part of the hub 32 to the end face 38 is configured as a bearing region 22 having an annular bearing surface 24 inclined convexly toward the first side 12 and the rotation axis 19. A coupling unit 18 is again provided in the hub 32 on the first side 12 of the rotor 30. The coupling unit 18 shown in the top half of the figure is again one half of a quick-action coupling, in particular a further embodiment of a bayonet catch 40. The one half, shown in the top half of FIG. 3, of this quick-action coupling is shown in FIG. 4 in full diameter in section along the line IV-IV in FIG. 3. It has circular-segment flanges 42 which project radially into the hollow cylinder of the coupling unit 18/40 and are uniformly distributed at a distance from one another over the circumference. As overtightening protection 41, the circular-segment flanges 42 have projections 43 which in each case project axially into the hollow cylinder and are arranged on that side of each circular-segment flange 42 which is situated in the clockwise direction. For the locking, a ramp-shaped recess 44 which serves to accommodate a locking element of the coupling device to be pushed in is provided in the coupling unit 18/40. A coupling device which is designed as a journal with circular-segment flanges of diametrically opposed design and forms the second half of this quick-action coupling can be pushed axially into the coupling unit 18/40 with its flanges offset from the circular-segment flanges 42 of the coupling unit 18/40 and can then be locked by a clockwise rotation. The circular-segment flanges of the two halves of the quick-action coupling then engage behind one another, in the course of which the circular-segment flanges are brought to bear against the projections 43 designed as overtightening protection 41 and then the locking element engages frictionally in the recess 44, which results in frictional locking against slackening and in protection against axial displacement. If required, that part of the hub 32 which projects beyond the moving blades 34 can be cut off after the machining has been completed.

Shown in the bottom half of FIG. 3 is a further embodiment of a coupling unit 18, which is shown in FIG. 5 again in full diameter in section along the line V-V in FIG. 3. Here, this involves a first half of a screwed connection 46, which is designed as a hollow cylinder with internal thread 48 and can be connected to a coupling device of diametrically opposed design.

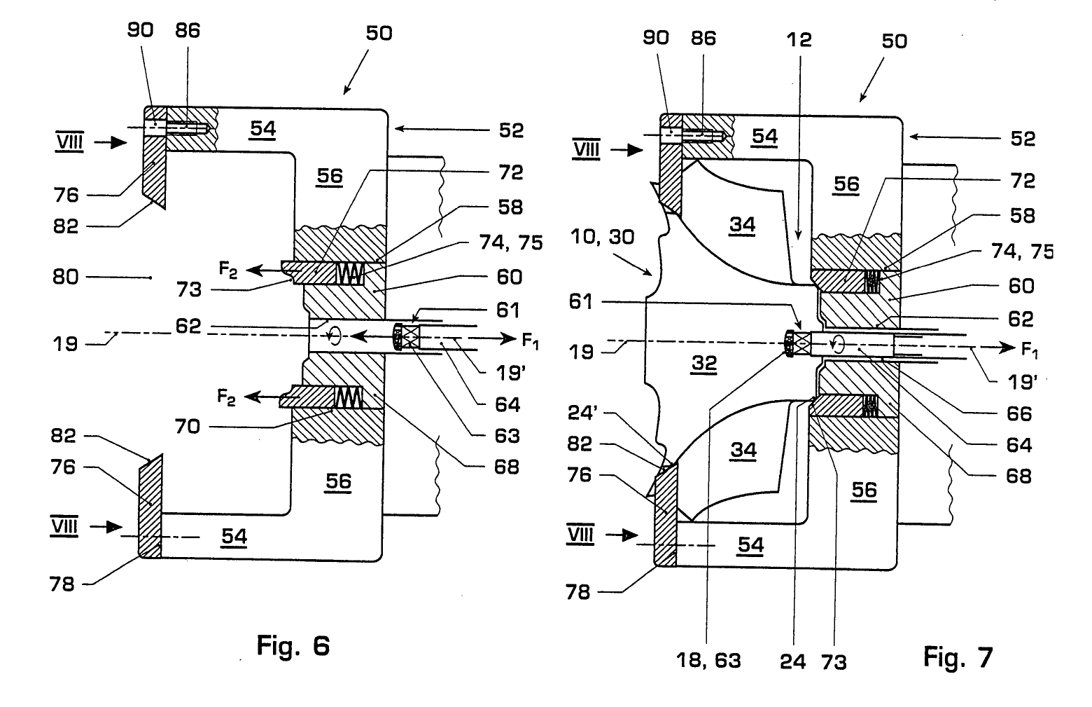

FIGS. 6 and 7 show a device 50 according to the invention for clamping rotationally symmetrical bodies 10 in a partial view in section along the rotation axis 19 of the bodies 10 to be clamped. FIG. 6 shows the device 50 according to the invention without body 10 to be clamped, whereas FIG. 7 shows the rotationally symmetrical body from FIG. 5 clamped in the device 50.

The device 50 comprises a support element 52 having a hollow-cylindrical wall 54 and a base 56 closing the hollow cylinder 54 on one side. The support element 52 has an axis 19′ which coincides with the rotation axis 19 of the body 10 to be clamped. An aperture 58 concentric to the axis 19′ in the base 56 serves to accommodate a stop 60. The stop 60 is a solid cylinder and has, concentrically to the axis 19′, a through-opening 62 in which a tie rod 64 is axially guided with radial clearance 66. At its working end 61, the tie rod 64 has a coupling device 63 which can be connected to the coupling unit 18 of the body to be clamped. The tie rod 64 as a whole, or else only its coupling device 63, is interchangeable and is designed so as to vary in adaptation to the coupling unit of the bodies to be clamped. The tie rod 64 is rotatable about its axis 19′ and is movable back and forth in the axial direction. The tie rod 64 can be actuated and the tensile force F1 set via a controllable hydraulic or pneumatic unit (not shown).

On its side remote from the body 10 to be clamped, the fixed stop 60 has a wide annular flange 68, the diameter of which corresponds approximately to the diameter of the aperture 58. It is fixed in the aperture 58 of the support element 52 via this annular flange 68, for example via a press fit. On its side opposite the annular flange 68, the stop 60 has a smaller diameter than the aperture 58, so that an annular gap 70 results between the base 56 of the support element 52 and the stop 60. Arranged in this gap 70 is a supporting element 72, which is supported in an axially movable and spring-loaded manner on the annular flange 68 of the fixed stop 60. The spring force F2 of the spring-loaded support 74 is oriented in the opposite direction to the tensile force F1. The supporting element 72 and the spring-loaded support 74 are designed to be interchangeable and so as to vary in adaptation to the bodies 10 to be clamped. The supporting element 72 has supporting surfaces 73 which are inclined toward the axis 19′ and, in this example, are contiguous to one another in the circumferential direction and form an annular surface. As can be seen in FIG. 7, the supporting surfaces 73 of the supporting element 72 interact with bearing surfaces 24 of the bearing region 22 on the first side 12 of the rotationally symmetrical body 10. The spring-loaded support 74 of the supporting element 72 is designed in such a way that, when a rotationally symmetrical body 10 is tightened against the supporting element 72 by means of the tie rod 64, the supporting element 72 gives way in the axial direction to begin with until either, when using a mechanical spring 75 as shown in this example, the latter is fully loaded, i.e. fully compressed for example, or the spring force F2 and the tensile force F1 are in equilibrium (the latter possible in the case of mechanical springs or hydraulically controlled spring mounting). For rotationally symmetrical bodies 10 to be clamped which have a small axial extent and a low weight, very accurate and reliable concentric clamping can thus already be achieved.

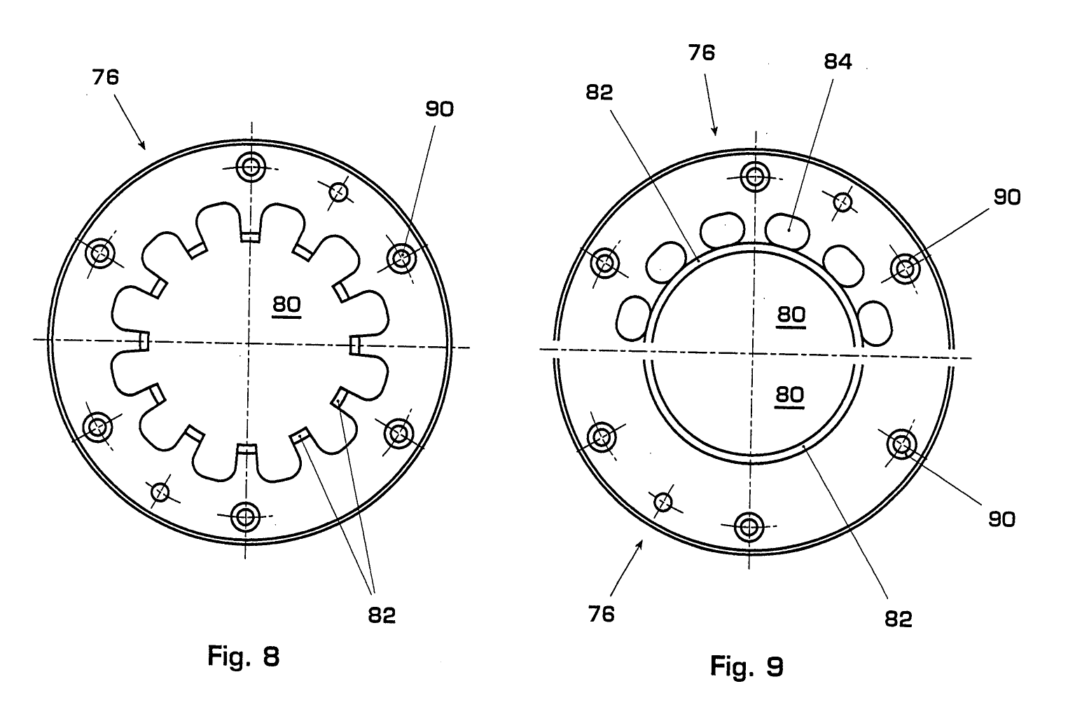

In the case of larger and heavier bodies 10, it is favorable to work with a centering device 76. Like the supporting element 72 and tie rod 64 or coupling device 63 of the tie rod 64, interchangeable centering devices 76 of various design are also provided. Examples of them are shown in FIGS. 8 and 9. The centering device 76 is of essentially disk-shaped design with a central opening 80. Provided concentrically around the opening 80 are centering surfaces 82, which in the examples shown in FIGS. 6 to 8 are inclined toward the axis 19. The centering surfaces 82, in adaptation to the bodies to be clamped, are designed and distributed in such a way that they can interact with the bearing surfaces 24′ of the centering region 28 of the body 10 to be clamped. To this end, the centering surfaces 82 can project in a finger-like manner into the central opening 80 of the disk-shaped centering device 76, as shown in FIG. 8. Such a configuration is appropriate if the body 10 to be clamped is a rotor 30 and the bearing surfaces 24′ are arranged between the moving blades 34, as in the rotor 30 shown in FIG. 3. In other cases, however, it may be appropriate to use a centering device 76 whose centering surfaces 82 are contiguous in the circumferential direction and thus form an annular centering surface, as shown in FIG. 9. In order to save material, and/or if this is desirable with regard to the vibration stiffness for example, the centering device 76 may have cutouts 84, as shown in the top half of FIG. 9, or it is possible to use a solid annular disk, as shown in the bottom half of FIG. 9. The centering disk 76 may have any other desired embodiment. Thus the centering surfaces 82 may be arranged on circles of different diameter or a plurality of disks may be used in which the centering surfaces 82 are at an axial distance from one another and if need be are arranged on different circle diameters.

In order to be able to exchange the centering disks 76, tapped holes 86 are provided on the end face 78 of the cylindrical wall 54 of the support element 52. The centering device 76 has openings 90 which can be aligned with the tapped holes 86. The centering devices are releasably fixed on the support element 52 by means of screws, which are put through the openings 90 of the centering devices 76 and screwed into the tapped holes in the wall 54.

In order to be able to clamp rotationally symmetrical bodies 10 of different axial length, it is conceivable for the cylinder wall 54 to be designed to be adjustable in length or for the centering devices to be fixed to a separate support instead of to the carrying element, this separate support being displaceable in the axial direction. Modifications are also conceivable with regard to the stop 60. Thus the stop 60, for example, may be designed in one piece with the support element 52. Or it may be provided as an interchangeable element whose end face facing the body 10 to be clamped is of varying design in adaptation to the respective requirements. Instead of a press fit, the fixing must then be produced by other suitable means, such as screws or clamped connections.

If a rotationally symmetrical body 10 configured according to the invention is now to be clamped in a device 50 according to the invention, the tie rod 64 is moved axially through the through-opening 62 of the stop 60 toward the rotationally symmetrical body 10. The coupling device 63 of the tie rod 64 is pushed into the coupling unit 18 of the rotationally symmetrical body 10 and the tie rod 64 rotated, so that the tie rod 64 is connected to the rotationally symmetrical body 10 in a releasable but tension-proof manner by means of the coupling device 18. The tie rod 64 is pulled back axially through the through-opening 62 and the bearing surfaces 24 of the bearing region 22 are brought into contact with the supporting surfaces 73 of the supporting element 72. When a centering device 76 is used, the bearing surfaces 24′ of the centering region 28 of the rotationally symmetrical body 10 should come into contact with the centering surfaces 82 of the centering device 76 approximately at this moment. During the further tightening, the supporting element 72 yields slightly axially until the spring force F2 and the tensile force F1 are in equilibrium or the spring 75 is correspondingly compressed and the supporting element 72 is supported fully on the annular flange 68 of the stop 60. Due to the special configuration of the supporting surfaces 73, centering surfaces 82 and bearing surfaces 24, 24′—arched or inclined—the rotationally symmetrical body 10 automatically orients itself coaxially and concentrically when being tightened against the supporting surfaces 73 or supporting and centering surfaces 73, 82. This is assisted by the elastically resilient supporting element 72. Due to the axial guidance of the tie rod 64 with radial clearance, canting can be avoided. If the body 10 to be clamped has a marking 9 which enables it to be clamped in the device 50 in each case with precisely the same spatial orientation, exact, concentric clamping is possible even if resetting is possibly required. If the marking 9 in the case of a cast body is already incorporated in the cast body, undesirable unbalance effects, as may occur with markings subsequently incorporated mechanically, can be avoided. It goes without saying that integrally cast markings should be applied in such a way that they are also, as far as possible, still visible on the clamped body and do not impair the functioning of the finish-machined body during use of the latter.

It goes without saying that the individual configurations of the individual elements of the rotationally symmetrical bodies and of the device can be combined in any desired manner in a technically appropriate manner by the person skilled in the art.

### List of Designations

10 Rotationally symmetrical body
12 First side
14 Cap
16 Hollow cylinder
18 Coupling unit
19, 19′ Rotation axis
20 Bayonet catch
22 Bearing region
24, 24′ Bearing region
26 Second side
28 Centering region
30 Rotor
32 Hub
34 Moving blade
36 Cylindrical outer surface
38 End face
40 Bayonet catch
41 Overtightening protection
42 Circular-segment flange
43 Projection
44 Ramp-shaped recess
46 Screwed connection
48 Internal thread
50 Device according to the invention
52 Support element
54 Hollow-cylinder wall
56 Base
58 Aperture
60 Stop
61 Working end of tie rod
62 Through-opening
63 Coupling device
64 Tie rod
66 Radial clearance
68 Annular flange
70 Gap
72 Supporting element
73 Supporting surfaces
74 Spring-loaded support
75 Spring
76 Centering device
78 End face
80 Central opening
82 Centering surface
84 Cutout
86 Tapped hole
90 Opening

1. A method of clamping a rotationally symmetrical body for the purpose of machining, in which method the body, with its first side, is pulled by means of a tensile force, which acts in extension of the rotation axis of the body on the first side of the body, against a supporting element having a centering effect, wherein the supporting element is acted upon with a spring force which is opposed to the tensile force, the spring force is slightly smaller than the tensile force and is proportioned in such a way that, when the body strikes the supporting element, the supporting element first of all yields in the axial direction.

2. The method as claimed in claim 1, wherein the tensile force is transmitted to the body by means of a tie rod, which is preferably connected to the body by means of a quick-action coupling.

3. The method as claimed in claim 2, wherein the tie rod is guided with radial clearance axially and concentrically to the rotation axis of the rotationally symmetrical body.

4. The method as claimed in claim 1, wherein the body, with a centering region which is arranged at an axial distance from the first side of the body and is oriented in the same direction as the first side, is pulled against a centering device.

5. The method as claimed in claim 1, wherein spring force, tensile force and configuration of supporting element are selected in accordance with the body to be clamped.

6. The method as claimed in claim 1, wherein, when a rotor is clamped as a rotationally symmetrical body which preferably has integrally formed moving blades, a centering device is selected which has centering surfaces engaging between the moving blades in a finger-like manner.

7. A device for clamping a rotationally symmetrical body for the purpose of machining, having a tie rod which is mounted in the device in such a way that it can act on the body, to be clamped, axially and concentrically to the rotation axis of the latter and is axially guided with radial clearance for the axial pulling movement, the tensile force of the tie rod preferably being adjustable, and having a supporting element, against which the rotationally symmetrical body to be clamped can be pulled by means of the tie rod, wherein the supporting element is supported in a spring-loaded manner on a stop of the device in such a way that it is movable in the axial direction of the body to be clamped, the spring force counteracting the tensile force and preferably being adjustable.

8. The device as claimed in claim 7, wherein the tie rod is provided with a coupling device which can be connected to a coupling unit of the body to be clamped and is preferably designed as the one half of a quick-action coupling.

9. The device as claimed in claim 7, wherein the supporting element is provided with supporting surfaces which are arranged concentrically to the rotation axis of the body to be clamped and which are preferably inclined toward the rotation axis and/or are contiguous along a defined circumference and form an annular supporting surface.

10. The device according to claim 7, wherein a centering device is provided at an axial distance from the supporting element, this centering device being provided with centering surfaces which are arranged concentrically to the rotation axis of the body to be clamped and are preferably inclined toward the rotation axis.

11. The device as claimed in claim 10, wherein the centering surfaces are distributed uniformly over the circumference and extend in a finger-like manner toward the rotation axis from a defined outer circumference up to a defined inner circumference and/or are contiguous in particular along a defined circumference and form an annular centering surface.
